(19) United States
(12) Patent Application Publication
(10) Pub. No.: US 2017/0097444 A1
(43) Pub. Date: Apr. 6, 2017

(54) INTEGRATED 3D METHOD FOR PREDICTION OF MUD WEIGHT WINDOW FOR COMPLEX WELL SECTIONS

(71) Applicant: LANDMARK GRAPHICS CORPORATION, Houston, TX (US)

(72) Inventors: Xinpu SHEN, Houston, TX (US); Xiaomin HU, Missouri City, TX (US); Xiuyun ZHENG, Sugar Land, TX (US); William Bradley STANDIFIRD, Fulshear, TX (US)

(21) Appl. No.: 15/128,058

(22) PCT Filed: Apr. 22, 2014
(86) PCT No.: PCT/US2014/035023

§ 371 Date: Sep. 21, 2016

(51) Int. Cl. G01V 99/00; G01N 9/36; G06F 17/50; E21B 41/00

(52) U.S. Cl. CPC G01V 99/005; E21B 41/0092; G01N 9/36; G06F 17/5018; E21B 47/00

(57) ABSTRACT

A method is provided for determining a mud weight window for an oil and gas well. One implementation of the method includes creating a 3D finite element model for at least a portion of the field in which the well is located. Next, at least three components of stress are determined using the 3D finite element model. The values of at least three of the stress components from the 3D finite element model may then be extracted and integrated with a ID analytical model for the well to determine the mud weight window for the well.

### TECHNICAL FIELD

The embodiments disclosed herein relate generally to methods and systems for an integrated 3D method for calculating mud-weight windows for complex well sections, particularly suited for horizontal oil and gas wells.

### BACKGROUND

Complex well sections refer to wells which include horizontal sections or high angle inclination well sections. Complex well sections often appear in the fields of unconventional resources, as well as those fields where there are complicated difficult zones such as salt, etc. Because the complex distribution of stress directions around those complicated difficult zones, accurate prediction of the mud-weight window (MWW) for complex well sections has presented a challenge to the industry for a long time.

The MWW is the range of values for mud density, which provides safe support to the wellbore during the drilling process at a given depth. If the value of mud weight is chosen within the range of the MWW, the wellbore is stable, and no plastic deformation should occur on the wellbore surface. Furthermore, with a safe mud weight selected within the MWW, no mud loss should occur as well. The MWW is defined by two boundaries: its lower boundary, which is the larger value of the pore pressure gradient (PP), or the shear failure gradient (SFG), which is the minimum mud weight required in keeping the wellbore away from plastic failure; and its upper boundary, which is the so-called fracture gradient (FG), which is the maximum value of mud weight that cannot induce any fracture opening. Because natural fractures usually exist within various kinds of formations and wellbores are mostly vertical, in practice, the value of minimum horizontal stress is taken as the value of FG.

In practice, the MWW of a given wellbore can be designed using either a one-dimensional (1-D) analytical method, or a three-dimensional (3-D) numerical finite-element (FE) method. The 1-D method determines horizontal stress components in terms of overburden stress and logging data along the wellbore trajectory, and only the information along the wellbore trajectory is used in determination of the MWW. This is the reason why it is defined as 1-D method. Geo-structure such as anticline and syncline are not considered in the calculation of MWW with a 1-D method. In pre-drill analysis, 1-D method usually uses the Top Table method to derive pore pressure and overburden gradient for the to-be drilled wellbore. The 1-D analytical tools for prediction of MWW are highly efficient, but require several assumptions to be adopted with the input data. These assumptions are usually reasonable, but may not be accurate enough for subsalt wells. In general, the 1-D method may not catch the variation of effective stress ratio within salt-base formation in both vertical and horizontal directions.

As a type of 3-D method, the FE method uses a 3-D model which consists of 3-D geometry and a 3-D mechanical constitutive relationship. The 3-D numerical method for prediction of MWW accurately calculates the geostress distribution within formations by a 3-D FE method. Details of geostructure such as syncline or anticline may be taken into account in its calculation. However, it is not as efficient as the 1-D method because prediction of MWW with 3D FE method requires building a submodel for key points along the trajectory. Therefore, its computational cost may be many times more than that required by a 1-D analytical method. Nevertheless, for complex well section such as subsalt well sections, values of MWW predicted by 1-D analytical method may be significantly different from the one predicted by 3-D FEM method because the effective stress ratio for the formation at salt base not only varies with TVD (true vertical depth), but also varies with horizontal positions. Thus, accurately predicting the MWW for a subsalt wellbore, 3D FE method may be essential.

### BRIEF DESCRIPTION OF DRAWINGS

FIG. 1 illustrates an exemplary work flow for determining a mud-weight window according to an embodiment of the disclosure;

FIG. 2 illustrates the geometry of a 3D finite element model for describing an oil field with salt formations according to an embodiment;

FIG. 3 shows a chart illustrating the results of SFG and FG obtained with a 1D method using PP and OBG as inputs;

FIG. 4 is a diagram illustrating 3D stress results showing the minimum principal stress at the salt-base formation according to the disclosure;

FIG. 5 is a diagram illustrating 3D stress results of a sectional view of the minimum principle stress in the plane, normal to the central axis of the salt body in three dimensional space, according to an embodiment;

FIGS. 6A-6C illustrate the distribution contours of effective stress components S₁₁, S₂₂, and S₃₃ according to an embodiment;

FIG. 7 is a chart showing the values of stress components from the points of a well-bore trajectory according to an embodiment;

FIG. 8 shows a graph illustrating exemplary values of FG, SHG, and OBG, generated according to an embodiment;

FIG. 9 shows values of SFG and ShG generated by a 1D model according to an embodiment;

FIG. 10 shows a chart illustrating a comparison a mud-weight window obtained with a 1D model compared to an embodiment of the disclosure; and

FIG. 11 is a table showing various parameter values used in an exemplary MWW determination according to an embodiment.

### DETAILED DESCRIPTION OF DISCLOSED EMBODIMENTS

As an initial matter, it will be appreciated that the development of an actual, real commercial application incorporating aspects of the disclosed embodiments will require many implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would nevertheless be a routine undertaking for those of skill in this art having the benefit of this disclosure.

It should also be understood that the embodiments disclosed and taught herein are susceptible to numerous and various modifications and alternative forms. Thus, the use of a singular term, such as, but not limited to, “a” and the like, is not intended as limiting of the number of items. Similarly, any relational terms, such as, but not limited to, “top,” “bottom,” “left,” “right,” “upper,” “lower,” “down,” “up,” “side,” and the like, used in the written description are for clarity in specific reference to the drawings and are not intended to limit the scope of the invention.

Embodiments of the disclosure provide an integrated 3D method for prediction of the mud-weight window (MWW) for complex well sections. According to one embodiment, the numerical results of all 3 stress components obtained by the finite-element method are used by the input data for a 1-D analytical calculation according to an embodiment.

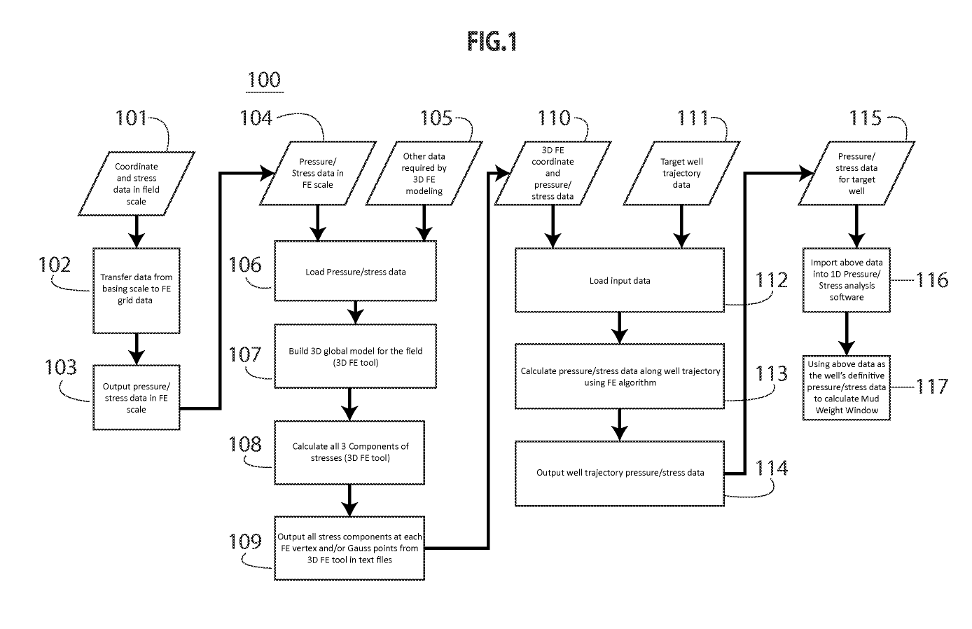

FIG. 1 is a flowchart illustrating the steps for determining an MWW according to an embodiment of the disclosure. This process may be implemented in any suitable software language, such as C#. Generally, data from a suitable 3-D Finite Element tool (“FE”), such as Abacus®, is combined with well trajectory data and a standard FE algorithm is used to extract data along the well path. More specifically, a method for determining mud-weight window according to an embodiment of the disclosure begins with converting field data to data suitable for finite element modeling. This involves steps 101-103 shown in FIG. 1 In step 101, coordinate and stress data from the field are scaled. In step 102, data from the reservoir basin scale is transferred to the field scale finite element grid. In one implementation, step 102 may be performed according to the process described in PCT/US2011/025732, entitled Generating Data For Geomechanical Modeling. In step 103, the pressure and stress data, now in finite element scale, are output for use in the following steps of the method.

The next step of a method according to an embodiment of these disclosures involves building a 3D global model for the field and calculating all three components of stress with the 3D finite element analysis tool. A 3-D global model for the field is constructed and all components of stress are calculated using a 3-D Finite Element tool (“FE”), such as Abacus®. In one embodiment, the step of building a global 3D model includes steps 104-109 shown in FIG. 1. In step 104, the initial pressure and initial stress data in finite element scale, are now used as an input to step 106 in which the pressure and stress data is loaded into the model. In step 105, other data required by the 3D finite element modeling, such as the formation's mechanical properties, etc., is also loaded into the model according to step 106.

Flow then proceeds to step 107 in which the 3D global model for the field is constructed using a suitable three-dimensional finite element tool, such as Abacus®. Flow then proceeds to step 108 in which all three components of stresses are calculated using the 3D finite element analysis tool. In step 109, the stress components at each finite element vertex and/or Gauss points from the 3D tool may be stored in computer memory, for example, as text files.

Next, the values of stress components for the points along the target well-bore trajectory, obtained from the 3D numerical results of the stress obtained in the previous step, are extracted. This is illustrated in steps 110-114 of FIG. 1. In step 110, the 3D finite element coordinates and pressure and stress data are provided as an input to step 112. In step 111, the target well trajectory data is also provided as an input to step 112 in which the input data is loaded into the system. Flow then proceeds to step 113 in which the pressure and stress data along the well trajectory are calculated using a finite element algorithm. Results of this calculation are then output in step 114 which provides the well trajectory and stress data information. In one embodiment, data process software may use the same algorithm as used in FE method to retain accuracy.

The six components of the stress tensor, S_{XX}, S_{YY}, S_{ZZ}, τ_{xy}, τ_{xz}, and τ_{yz}, obtained using FE analysis, may be advantageously transferred into a local coordinate system. The local coordinate system uses target trajectory axial direction as its local direction. Normal stress components and shear stress components will be transferred to this local coordinate system first. Then, minimum horizontal stress (ShG) and maximum horizontal stress (SHG) components will be redefined in the cross-sectional plane perpendicular to the trajectory axial direction. Here, the term “horizontal” is used to refer to the plane of a cross section to the trajectory.

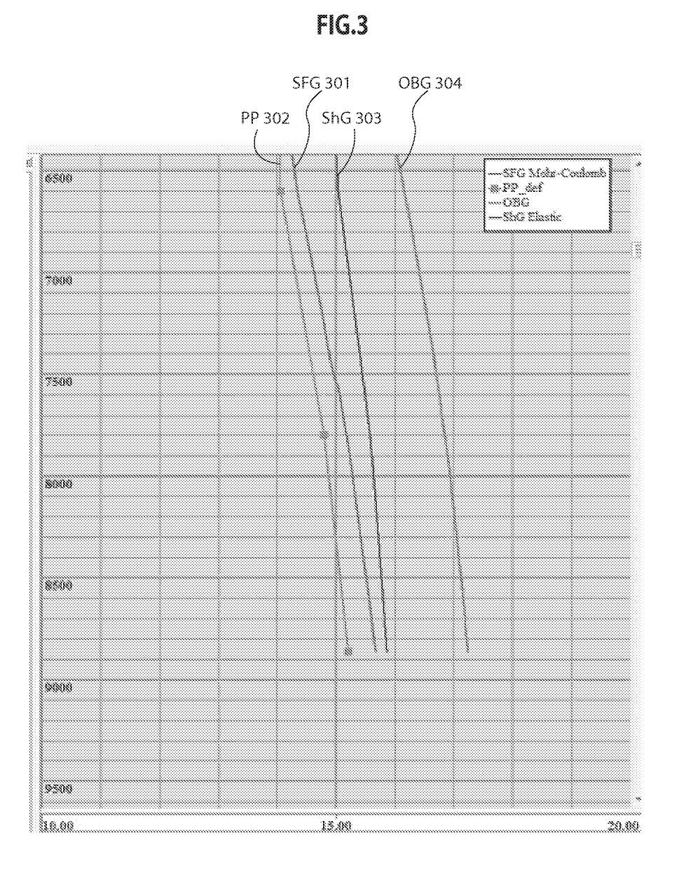

As shown in FIGS. 3-5, the existence of the salt body causes not only the directions of the 3 principal stress components to vary with location, but also the order of magnitude of the 3 principal stress components to vary as well. Therefore, at some point in the 3-D space, Sxx may be ShG, but at another point, Syy could be ShG. The data process software, according to an embodiment, calculates ShG and SHG at every point of the 3-D space investigated.

Next, the 3D data of the stress components is imported into the 1D analytical tool. A suitable 1D analytical tool may include, for example, Drillworks™, available from Halliburton Corporation. At the same time, other conventional input data such as pore pressure and strength parameters may also be provided to the 1D analytical tool. The mud weight window may then be calculated according to an embodiment of the disclosure, along with other conventional input data, such as pore pressure and strength parameters. This step is described in more detail in steps 115-117 of FIG. 1. In step 115, pressure and stress for the target well are obtained from step 114. Information is provided as an input into the 1D pore pressure stress analysis software, such as Drillworks™ in step 116. Finally, in step 117, using the information calculated above as the well's definitive pressure and stress data, the MWW is calculated.

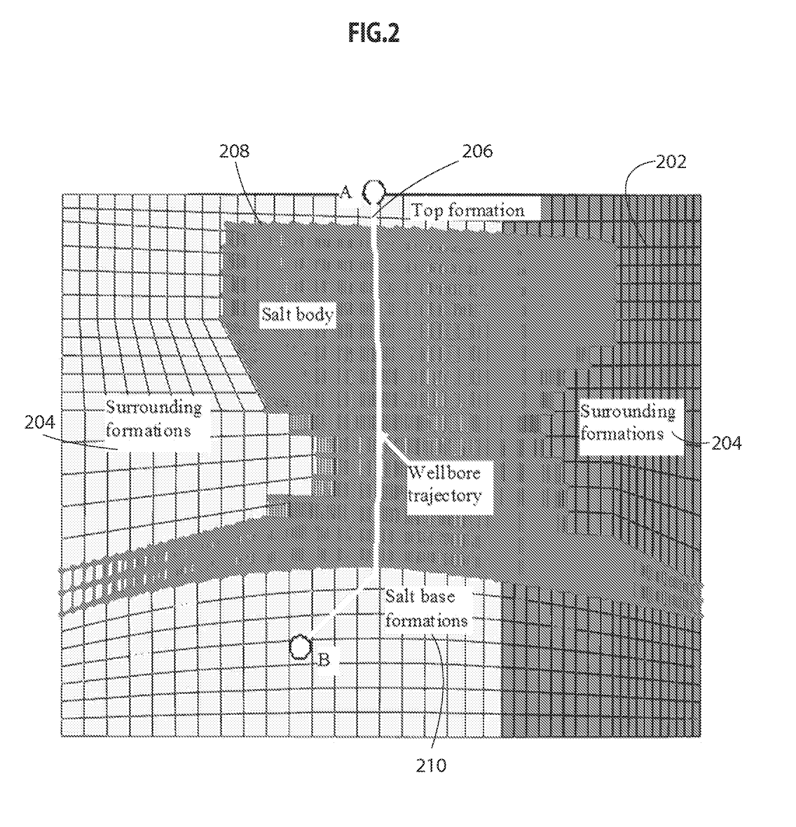

FIGS. 2-10 illustrate an embodiment of the disclosure using a subsalt inclined well section. The geometry of the 3-D Finite Element model which describes the field with salt formations is shown in FIG. 2. Embodiments of the disclosed method, are compared with a 1-D solution obtained with Drillworks Predict™ to illustrate in more detail aspects of the disclosure.

One dimensional determination of MWW may include two categories of input data. The first category of input data may include pore pressure (PP), overburden gradient (OBG), effective stress ratio/or Poisson's ratio, and tectonic stress factor. The second category may include cohesive strength (CS), friction angle, (FA) and/or uniaxial compression strength (UCS). The first category of the input data is used in connection with the determination of the upper bound of MWW, which is FG. The second category of input data is used in connection with the determination of the lower bound of MWW, which is SFG. Among these data, the effective stress ratio is used in the calculation of minimum horizontal stress (may be regarded as FG), and the tectonic factor is used in the calculation of maximum horizontal stress in terms of ShG and OBG. Poisson's ratio is an alternative for the input of effective stress ratio. Suitable 1D software, such as Drillworks™, can calculate effective stress ratio in terms of Poisson's ratio. The effective stress ratio k₀ is defined by:

$${k}_{0} = \frac{{S}_{h} - pp}{OBG - pp}$$

where Sₕ is the minimum horizontal stress where is the minimum horizontal stress.

FIG. 2 illustrates the trajectory of the wellbore 202 through the surrounding formation 204, as well as the formations where the wellbore goes through. The wellbore 206 is a vertical well through a salt body 208. The thickness of the salt body 208 where the wellbore 206 goes through is 5,600 meters, in this example. The width of the model built in the calculation is 8,000 m, and the height is 9,000 m. The target formation is at the salt base 210, which is at the TVD interval of 7,500 to 8,500 m. Determination of the MWW is preferably made at this TVD interval. The values of material parameters are given in the table shown in FIG. 11. Values for the effective stress ratio k₀ may be calculated in terms of Poisson's ratio according to the equation:

$${k}_{0} = \frac{v}{1 - v}$$

With the given values of Poisson's ratio in the table shown in FIG. 11, the effective stress ratio can be obtained as 0.43.

The tectonic factor is another kind of stress-related input data. It is used to determine the SFG, which is the lower bound of the MWW. The definition of tectonic factor is:

$${t}_{f} = \frac{{S}_{H} - {S}_{h}}{OBG - {S}_{h}}$$

where S_{H} is the maximum horizontal stress. When t_{f}=0, S_{H}=Sₕ; when t_{f}=1, S_{H}=OBG. The value of t_{f} is set typically between 0 and 1. Using 1-D analysis, the value of t_{f} is determined by the method of ‘phenomena fitting’. The drilling report and image log of an offset well in the neighborhood of the target well are required to obtain a reasonable value of t_{f} using a 1-D method. If any breakout is found in the image logging data of the wellbore, the value of t_{f} may be adjusted to let the shear failure occur at that position. The process for determining t_{f} is rather experience-dominated. In practice, specific geo-structures have significant influence on the value of t_{f} in the region. However, limited by its 1-D property, 1-D method does not take geo-structural factors into the value of t_{f}. On the other hand, a 3-D FE model can build the geo-structure into the model and, thus, naturally takes the influence of the geo-structure into account in the SFG calculation.

To further illustrate an embodiment of the disclosure, the value of t_{f} may be set at 0.5, which indicates that the maximum horizontal stress S_{H}, is in the middle between Sₕ and OBG. Mohr-Coulomb plastic yielding criterion is adopted in the calculation. Frictional angle and cohesive strength are listed in the table shown in FIG. 11. These values will also be used in the numerical calculation with the 3-D FE model. Values of pore pressure and overburden gradient for the given TVD intervals are obtained with the Top Table method and logging data from offset wells, and are shown in FIG. 3. Values for pore pressure (PP) 302, SFG 301, ShG 303, and OBG 304 for depths of about 6500 m to 8850 m are depicted.

FIG. 3 shows a chart illustrating the results of SFG and FG obtained with a 1D method using PP and OBG as inputs. The y-axis depicts the TVD in meters. The x-axis depicts PPG (pumps per gallon). With the given input data introduced above, the MWW of the 1-D solution using Drillworks™ is shown in FIG. 3. Because the formation strength is rather weak, FIG. 3 illustrates that the MWW is rather narrow for the salt-base well section.

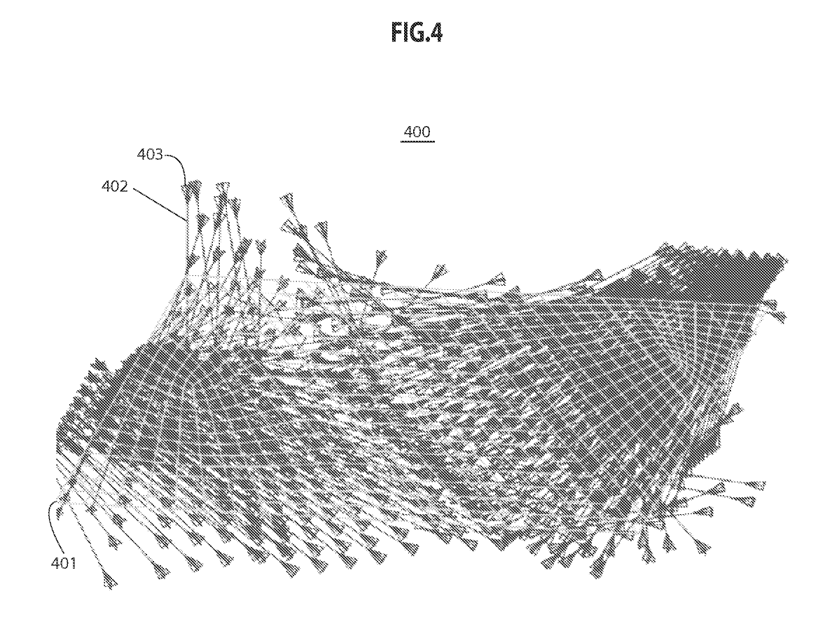

A further embodiment of the disclosure having an integrated 3-D MWW solution including stress components obtained using 3-D finite-element analysis is also described with reference to FIGS. 2-10. In one implementation of the method, an initial calculation is made of values of the gradient of the stress components using 3-D FE analysis. An exemplary 3-D finite-element model of the field is shown in FIG. 2. Boundary conditions of zero normal displacement have been applied to 4 lateral sides as well as the bottom surface. Gravity is the load that balances initial geostress field and pore pressure. A linear elastic constitutive model is used to model the formation and surrounding rocks, and a visco-elastoplastic model is used to model salt rock. The numerical results of the directions of maximum and minimum principal stress components are shown in FIGS. 4 and 5, respectively.

FIGS. 4 and 5 show vector distributions of the minimum principal stress at the salt-base formation in the planes of XOY and YOZ in three dimensional space respectively. FIG. 4 depicts the distribution of the minimum principal stress 400 in the horizontal plane against the finite element mesh 401. The stress direction is indicated by vectors, such as vector 402, having direction arrows, such as arrow 403. The direction is indicated at the location where vectors 402 intersect finite element mesh 401. FIG. 5 similarly shows a distribution of the minimum principal stress 500 against finite element mesh 501 using vectors 502 having direction arrows 503, except in FIG. 5 the distribution is for the vertical direction. In both FIGS. 4 and 5, the stress is determined in the subterranean formation where the wellbore is located. From FIGS. 4 and 5, it can be seen that directions of the minimum principal stress vector in the neighborhood of a salt body varies significantly from place to place, resulting in an irregular distribution of the effective stress ratio within formations. Furthermore, orders of principal stress magnitude also vary from place to place.

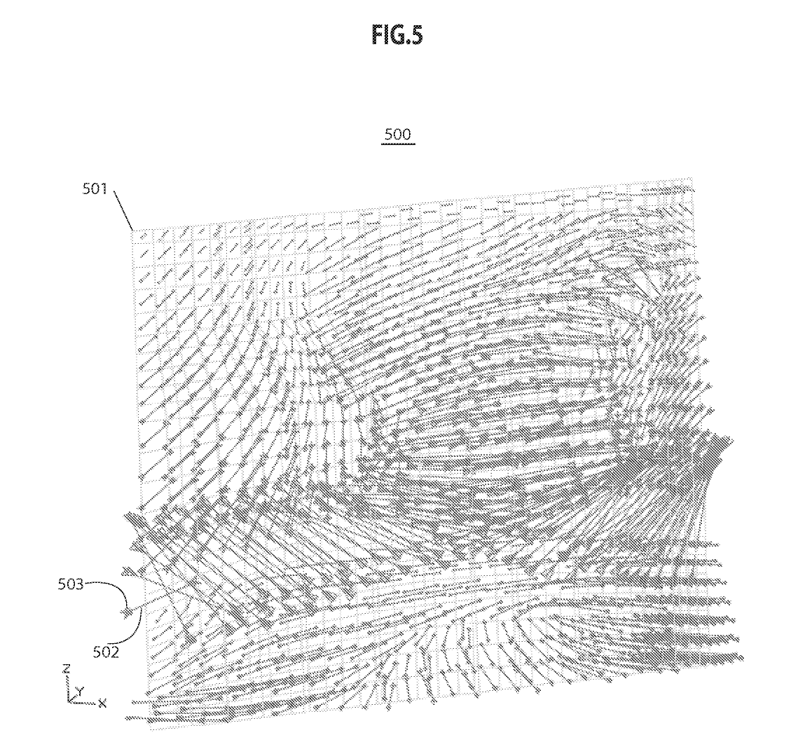

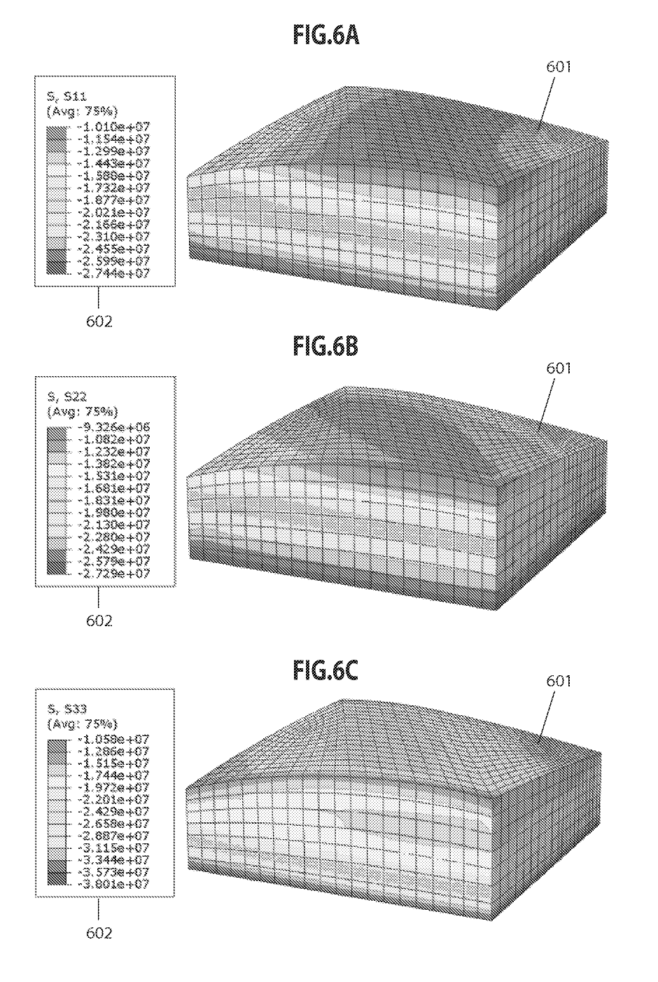

FIGS. 6A-6C show distribution contours of effective stress components S11, S22 and S33, which are stress components in xx, yy, and zz directions, respectively.

The magnitudes of the stress components are depicted by the shading of the contour against the finite element grids 601, with the magnitudes provided numerically in Pascals (Pa.) in text boxes 602 at a location in the formation.

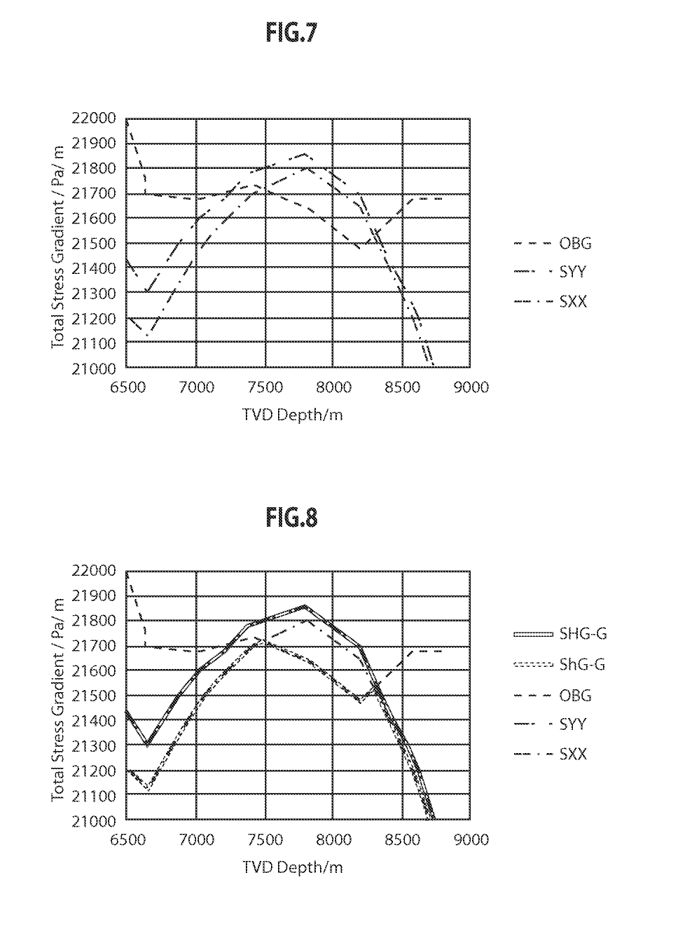

The numerical results shown in FIGS. 4-6C were obtained with a data processor executing the steps illustrated in FIG. 1, which generates values of stress components for the points of the wellbore trajectory shown in FIG. 2. Part of the data for ShG, SHG, and OBG are shown in FIGS. 7 and 8. From FIG. 7 it is seen that the local stress component OBG is the largest one at the TVD interval 6500 meters (m) to about 7200 m, while it is the smallest one at the TVD interval 7500 m to 8300 m. Therefore the FG is formed by ShG at the following two TVD intervals 6500 to 7500 m and from 8300 to 8800 m, and by the OBG at the TVD interval from 7500 to 8300 m. This is because within the TVD interval 7500 to 8300 m, OBG is the minimum stress component.

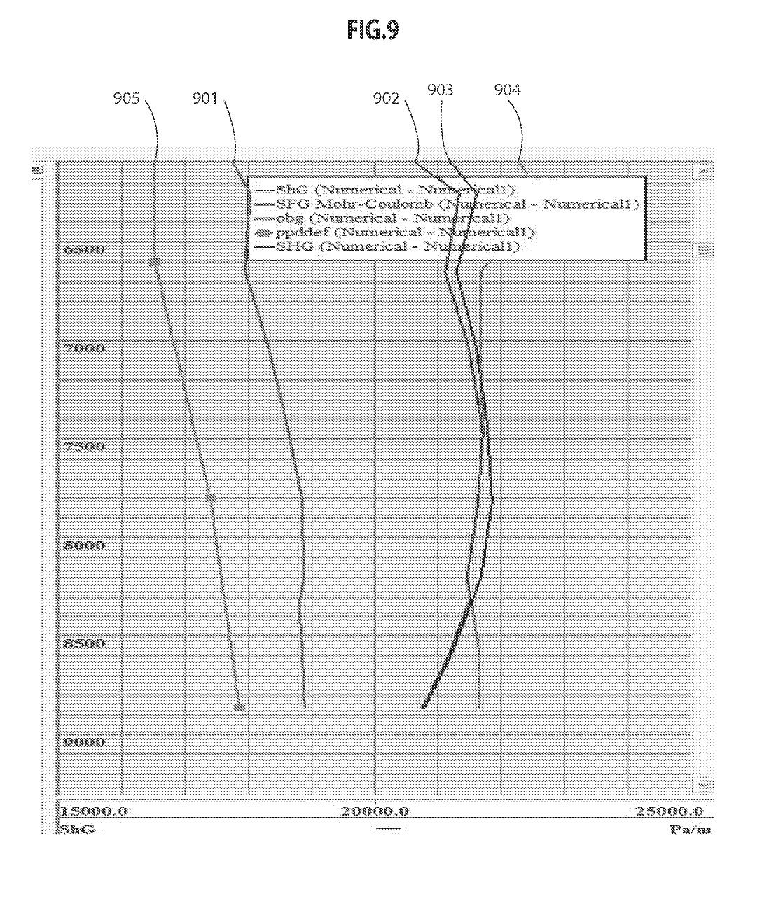

Next, the curves ShG-G, SHG and OBG are input to the integrated model according to an embodiment. In one implementation, the integrated model includes a suitable software application, such as Drillworks™, provided with stress tensor data from the processor executing the process described in FIG. 1. The same strength parameters used for 1-D calculation are used in the integrated embodiment. This results in the integrated 3-D MWW solution, shown in FIG. 9.

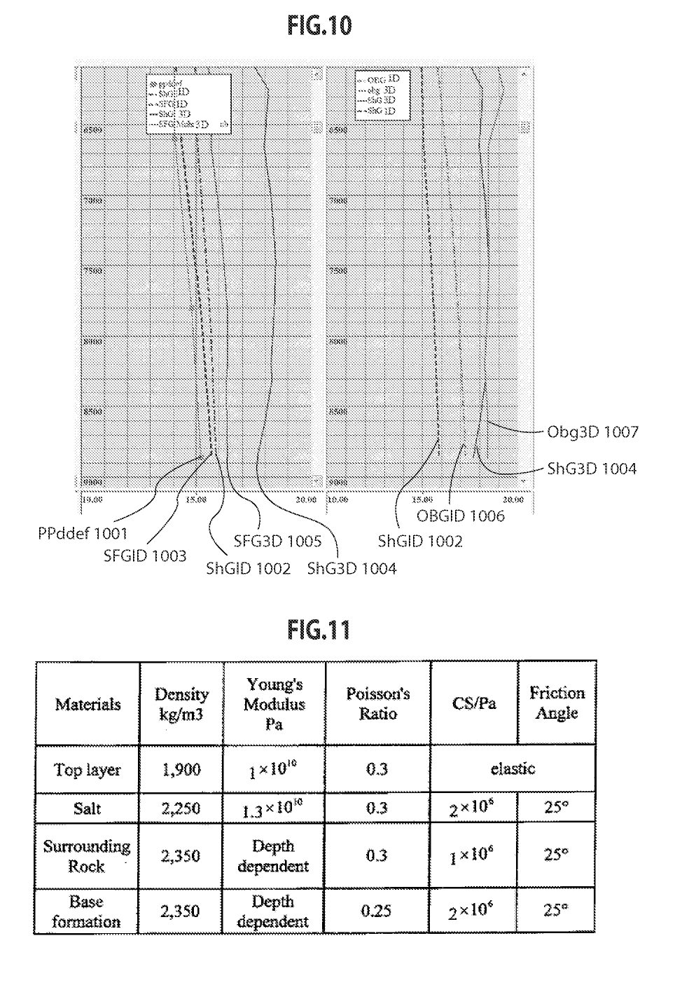

FIG. 9 shows values of SFG 901 and ShG 902 generated by a 1D model according to an embodiment. Also shown are SHG 903, OBG 904, and ppddef (definitive pore pressure) 905. FIG. 10 compares values obtained using a 1-D method with integrated 3-D method according to an embodiment.

FIG. 10 shows two data display tracks for MWW parameters for a well at a TVD of between 6,000 and almost 9,000 meters for a PPG rate of between 10 and 20. The left track of FIG. 10 shows ppddef 1001, ShG 1D 1002, SGF 1D 1003, ShG 3D 1004, and SFG 3D 1005. The track on the right shows ShG 1D 1002, ShG 3D 1004, OBG 1D 1006, and OBG 3D 1007. From the left track of FIG. 10, it is seen that the MWW obtained with an embodiment of the integrated 3D method has shifted to the right side, and has a much larger safe mud window. This is because the local stress distribution is seriously influenced by the anticline structure of the salt bottom. In this example, the value of OBG is significantly smaller than the value obtained using a 1D method, while the ShG is significantly larger than that of the 1D solution. The right track of FIG. 10, further shows a comparison between the solution of OBG and Shg/FG obtained with the two methods, respectively.

While the disclosed embodiments have been described with reference to one or more particular implementations, those skilled in the art will recognize that many changes may be made thereto without departing from the spirit and scope of the description. Accordingly, each of these embodiments and obvious variations thereof is contemplated as falling within the spirit and scope of the following claims.

What is claimed is:

1. A method for determining a mud weight window for a well, comprising:
creating a 3D finite element model for at least a portion of the field in which the well is located;
determining at least three out of six components of stress using the 3D finite element model;
extracting the values of the at least three out of six stress components from the 3D finite element model;
integrating the at least three out of six components of stress in a 1D analytical model for the well; and
determining a mud weight window.

2. The method according to claim 1, further comprising determining all components of stress using the 3D finite element model.

3. The method according to claim 1, wherein the stress components comprise the six components of stress tensor, S_{XX}, S_{YY}, S_{ZZ}, τ_{xy}, τ_{xz}, and τ_{yz}.

4. The method according to claim 1, wherein the values of the at least three out of six stress components from the 3D finite element model are extracted with respect to the geometry of the wellbore trajectory.

5. The method according to claim 1, further comprising scaling and transferring coordinate and stress data from the field to a field scale finite element grid.

6. The method according to claim 1, wherein pressure and stress data along the well trajectory are calculated using a finite element algorithm.

7. The method according to claim 1, wherein the six components of the stress tensor are transferred into a local coordinate system.

8. A computer readable medium having a program of instructions executable by a computer processor that, when executed, cause the computer to perform a method comprising:
creating a 3D finite element model for at least a portion of the field in which the well is located;
determining at least three out of six components of stress using the 3D finite element model;
extracting the values of the at least three out of six components of stress from the 3D finite element model;
integrating the at least three out of six components of stress in a 1D analytical model for the well; and
determining a mud weight window.

9. A computer readable medium according to claim 5, wherein the method further comprises determining all components of stress using the 3D finite element model.

10. A computer readable medium according to claim 5, wherein the stress components comprise the six components of stress tensor, S_{XX}, S_{YY}, S_{ZZ}, τ_{xy}, τ_{xy}, and τ_{yz}.

11. A computer readable medium according to claim 5, wherein the values of the at least three out of six stress components from the 3D finite element model are extracted with respect to the geometry of the wellbore trajectory.

12. A computer readable medium according to claim 5, wherein the method further comprises scaling and transferring coordinate and stress data from the field to a field scale finite element grid.

13. A computer readable medium according to claim 5, wherein pressure and stress data along the well trajectory are calculated using a finite element algorithm.

14. A computer readable medium according to claim 5, wherein the six components of the stress tensor are transferred into a local coordinate system.

15. A system for determining a mud weight window in an oil and gas well comprising:
a computer processor;
a computer display;
a computer readable medium having a program of instructions executable by a computer processor that, when executed, cause the computer to perform a method comprising:
creating a 3D finite element model for at least a portion of the field in which the well is located;
determining at least three out of six components of stress using the 3D finite element model;
extracting the values of the at least three out of six components of stress from the 3D finite element model;
integrating the at least three out of six components of stress in a 1D analytical model for the well; and
determining a mud weight window.

16. A system according to claim 15, wherein the method further comprises determining all components of stress using the 3D finite element model.

17. A system according to claim 15, wherein the stress components comprise the six components of stress tensor, S_{XX}, S_{YY}, S_{ZZ}, τ_{xy}, τ_{xz}, and τ_{yz}.

18. A system according to claim 15, wherein the values of the at least three out of six stress components from the 3D finite element model are extracted with respect to the geometry of the wellbore trajectory.

19. A system according to claim 15, wherein the method further comprises scaling and transferring coordinate and stress data from the field to a field scale finite element grid.

20. A system according to claim 15, wherein pressure and stress data along the well trajectory are calculated using a finite element algorithm and the six components of the stress tensor analysis are transferred into a local coordinate system.
